(19) United States
(12) Patent Application Publication
(10) Pub. No.: US 2009/0154707 A1
(43) Pub. Date: Jun. 18, 2009

(54) METHOD AND SYSTEM FOR DISTRIBUTING GROUP KEY IN VIDEO CONFERENCE SYSTEM

(76) Inventors: Taek Kyu LEE, Daejeon (KR); Chang Su HONG, Gyeonggi-do (KR); Sang Yi YI, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/171,662

(22) Filed: Jul. 11, 2008

(30) Foreign Application Priority Data
Dec. 18, 2007 (KR) 10-2007-0133578

(51) Int. Cl. H04L 9/08

(52) U.S. Cl. 380/278

(57) ABSTRACT

Provided are a system and method for distributing a group key for a video conference using a one-time password in a video conference system. The method includes: when a video terminal is required to participate in a video conference, generating a challenge value and a response value corresponding to the video terminal; encrypting a group key corresponding to the video conference with the response value, and transmitting the encrypted group key and the challenge value to the video terminal; and causing the video terminal to participate in the video conference in response to an acknowledgement message from the video terminal. This results in high user friendliness and high-level security.

### CROSS-REFERENCE TO RELATED APPLICATION

This application claims priority to and the benefit of Korean Patent Application No. 2007-133578, filed Dec. 18, 2007, the disclosure of which is incorporated herein by reference in its entirety.

### BACKGROUND

1. Field of the Invention

The present invention relates to a system and method for distributing a group key in a video conference system, and more particularly, a system and method for distributing a group key for a video conference using a one-time password.

2. Discussion of Related Art

With recent rapid development of communication network technology and the advent of information society in which rapid acquisition of much information is of importance, users demand advanced transmission service for multimedia information including sound, image, and moving picture, in addition to existing telephone and data transmission service. Video conference as a representative application using multimedia transmission service has been studied, and developed and implemented in a variety of environments.

The rapid development of communication network technology enables a variety of services to be provided to users, but may also expose personal information. Accordingly, a variety of authentication schemes for protecting personal information have been introduced.

Authentication in a communication network normally includes confirming a user attempting to access a system or a network. The authentication process is the most basic and essential process of protecting principal assets such as computers and networks.

There are three authentication schemes which are primarily used in a communication network.

A first authentication scheme is to confirm something you know, a second authentication scheme is to confirm something you have, and a third authentication scheme is to confirm you yourself.

Among the three authentication schemes, the authentication scheme of confirming something the user knows, e.g., a log-on password, is most widely used on computer networks. In this scheme, when a user-input password is correct, the user is authorized.

However, in the scheme of confirming the log-on password, a password may be robbed, exposed due to carelessness, or lost. This problem is particularly more severe in financial transaction service. To solve the problem, a more powerful authentication scheme is necessary.

As more powerful authentication, Two-Factor Authentication (T-FA) using a combination of two of the three methods has been proposed. The two-factor authentication is widely used for applications necessitating powerful user authentication.

The two-factor authentication is commonly based on both ‘Something you know’ and ‘Something you have’. Representative examples of the two-factor authentication include a credit card, a cash card, and Internet banking service. The card itself is what a user has physically (“What you have”), and a password corresponding to this card is what the user knows (“What you know”). The two factors are required for successful authentication.

The two-factor authentication greatly reduces damage due to on-line fraudulent use of an ID. This is because one cannot access desired information or system through fraudulent use of a password without holding a card. Accordingly, the two-factor authentication provides much higher security than typical authentication. However, there are some constraints obstructing spreading of the two-factor authentication. That is, users tend to dislike carrying something new. Furthermore, enterprises have adopted different two-factor authentications, resulting in low compatibility.

Thus, an authentication scheme capable of providing both powerful security and user friendliness is urgently necessary. One example of such an authentication scheme includes one-time password (OTP) authentication. The OTP authentication uses a new password every use.

However, the OTP authentication is applied only to a specific device such as a mobile terminal, or specific service such as paid service on the Internet. For high security and user friendliness, the OTP authentication must be applied to a variety of devices and services. In particular, for video conferences of recently increasing demand, there have been efforts to achieve high security and user-friendliness using the OTP authentication.

### SUMMARY OF THE INVENTION

The present invention provides a system and method for distributing a group key for a video conference in a video conference system using a one-time password.

The present invention also provides a system and method for distributing a group key using a challenge/response system in a video conference system using a one-time password.

The present invention also provides a system and method for distributing a group key using a time synchronization system in a video conference system using a one-time password.

The present invention also provides a system and method for distributing a group key in a video conference system using a challenge/response system in response to a request from a multipointing control unit in a video conference system using a one-time password.

The present invention also provides a system and method for distributing a group key using a challenge/response system in response to a request from a video terminal in a video conference system in a video conference system using a one-time password.

The present invention also provides a system and method for distributing a group key using a time synchronization system in response to a request from a multipointing control unit in a video conference system using a one-time password.

The present invention also provides a system and method for distributing a group key using a time synchronization system in response to a request from a video terminal in a video conference system using a one-time password.

Further objects of the present invention will be appreciated from a description below and exemplary embodiments of the present invention.

One aspect of the present invention provides a method for distributing a group key in a video conference system, the method including: when a video terminal is required to participate in a video conference, generating a challenge value and a response value corresponding to the video terminal; encrypting a group key corresponding to the video conference with the response value, and transmitting the encrypted group key and the challenge value to the video terminal; and causing the video terminal to participate in the video conference in response to an acknowledgement message from the video terminal.

Another aspect of the present invention provides a system for distributing a group key in a video conference system, the system including: an one-time password module for generating a challenge value and a response value corresponding to a video terminal; and a multipointing control unit for, when the video terminal is required to participate in a video conference, encrypting a group key corresponding to the video conference with the response value, transmitting the encrypted group key and the challenge value to the video terminal, and causing the video terminal to participate in the video conference in response to an acknowledgement message from the video terminal.

Still another aspect of the present invention provides a method for distributing a group key in a video conference system, the method including: when a video terminal is required to participate in video conference, generating a one-time password at a specific time based on synchronization time information with the video terminal; encrypting a group key corresponding to the video conference with the generated one-time password and transmitting the encrypted group key to the video terminal; and causing the video terminal to participate in the video conference in response to an acknowledgement message from the video terminal.

Yet another aspect of the present invention provides a system for distributing a group key in a video conference system, the system comprising: a one-time password module for generating a one-time password at a specific time based on synchronization time information with a video terminal; and a multipointing control unit for, when a video terminal is required to participate in a video conference, encrypting a group key corresponding to the video conference with the generated one-time password, transmitting the encrypted group key to the video terminal, and causing the video terminal to participate in the video conference in response to an acknowledgement message from the video terminal.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates one example of a video conference system according to the present invention;

FIG. 2 schematically shows a process in which a video terminal participates in a video conference in a video conference system according to the present invention;

FIG. 3 schematically shows a process of distributing a group key when there are a plurality of video conference groups;

FIG. 4 shows a signal processing flow in a video conference system of distributing a group key according to a first embodiment of the present invention;

FIG. 5 shows a control flow in an MCU for initiating a video conference through group key distribution according to the first embodiment of the present invention;

FIG. 6 shows a control flow in a video terminal for initiating a video conference through group key distribution according to the first embodiment of the present invention;

FIG. 7 shows a signal processing flow in a video conference system of distributing a group key according to the first embodiment of the present invention;

FIG. 8 shows a control flow in a video terminal for initiating a video conference through group key distribution according to the first embodiment of the present invention;

FIG. 9 shows a control flow in an MCU for initiating a video conference through group key distribution according to the first embodiment of the present invention;

FIG. 10 shows a signal processing flow in a video conference system of distributing a group key according to a second embodiment of the present invention

FIG. 11 shows a control flow in the MCU for initiating a video conference through group key distribution according to the second embodiment of the present invention;

FIG. 12 shows a control flow in a video terminal for initiating a video conference through group key distribution according to the first embodiment of the present invention;

FIG. 13 shows a signal processing flow in a video conference system of distributing a group key according to the first embodiment of the present invention;

FIG. 14 shows a control flow in a video terminal for initiating a video conference through group key distribution according to the first embodiment of the present invention; and

FIG. 15 shows a control flow in an MCU for initiating a video conference through group key distribution according to the first embodiment of the present invention.

### DETAILED DESCRIPTION OF EXEMPLARY EMBODIMENTS

Hereinafter, exemplary embodiments of the present invention will be described in detail with reference to the accompanying drawings. The embodiments of the present invention, however, may be changed into several other forms, and the scope of the present invention should not be construed to be limited to the following embodiments. The embodiments of the present invention are intended to more entirely explain the present invention to those skilled in the art.

An OTP scheme for use in the present invention will be briefly described prior to detailed description of exemplary embodiments of the present invention.

A One-Time Password (OTP) commonly provides powerful security because it is newly generated every specific communication, which prevents an exposed password from being reused. The OTP system may be classified into a Challenge/Response system and a synchronization system.

The challenge/response system is based on responding to a challenge value from an OTP server, and the synchronization system is based on synchronization between an OTP server and a terminal. The synchronization system may be classified into a time synchronization system and an event synchronization system.

First, in the challenge/response system, a random number provided from an authentication server or a transaction process is input to a one-time password generator to generate a new password. The challenge/response system forces a user to input something to a password generator in order to generate the new password, which is inconvenient to the user. A token generates a new password through a hash function using a random number value from a server and a secret value stored in the token as inputs. Since a challenge value and a response value are exchanged between a server and a client, mutual authentication is possible, but generation or regeneration of the same challenge value and response value may cause security degradation.

Second, the time synchronization system uses both a secret key value and a current time as inputs of a hash function. The time synchronization system is based on time synchronization between a server and a client. The time synchronization system is widely used in OTP solutions using physical hardware tokens. All users have a hardware token capable of generating a one-time password, which includes a clock providing accurate time. The clock must be synchronized with another clock in the authentication server. In the time synchronization system, a time is a key element for password generation.

Finally, the event synchronization system further uses, as a hash value input, a number of times any specific event occurs, such as a number of times a user presses a password generator to generate a one-time password. In the event synchronization system, an OTP token normally includes one counter allowing the number of times a user presses a password generator to be used as an input value of an algorithm. However, nonuse of the generated password causes a difference in event occurrence number between the OTP token and the authentication server, which necessitates further synchronization. For security, when the difference in the event occurrence number exceeds a limit, initialization is inconveniently necessary.

Besides, there is a hybrid system, which is a combination of the time synchronization system and the event synchronization system to overcome their respective shortcomings.

Meanwhile, a first embodiment of the present invention proposes a scheme of distributing a group key based on the challenge/response system, and a second embodiment proposes a scheme of distributing a group key based on the time synchronization system. An example in which a video conference is requested by a Multipointing Control Unit (MCU) and an example in which a video conference is requested by a video terminal according to first and second embodiments of the present invention will be described.

Hereinafter, exemplary embodiments of the present invention will be described in detail with reference to the accompanying drawings.

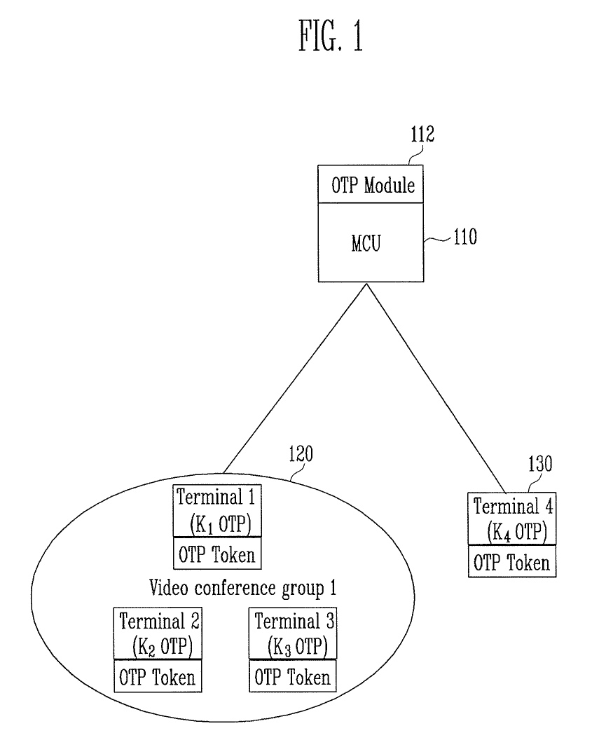

FIG. 1 illustrates one example of a video conference system according to the present invention.

Referring to FIG. 1, an MCU 110 is a multipointing control unit for distributing and controlling images and sound of a sender participating in a video conference. The OTP module 112 holds a personal OTP and a key for group communication (hereinafter, “group key”), and is included in and cooperates with the MCU 110. In the challenge/response system, a key is asynchronously shared with an OTP token module included in and cooperating with the video terminal. In the time synchronization system, a one-time password is generated based on synchronization time information with an OTP token module included in and cooperating with video terminal.

The video terminal group 120 is a group of video terminals for group video conference using a group key acquired from the MCU 110 by the challenge/response system or the time synchronization system. The video terminal in the video terminal group 120 uses a unique one-time password, but uses the same group key to participate in the video conference.

Video terminals belonging to the video terminal group 120 and the standalone video terminal 130 are user communication equipment for accessing the MCU 110 to participate in the video conference. The video terminal has an authentication function based on user OTP input.

The OTP token module is activated through a user authentication process in the video terminal, and is included in and cooperates with the video terminal. The OTP token module shares a key asynchronously with the OTP token module 112 that is included in and cooperates with the MCU 110 in the challenge/response system, and generates a one-time password based on synchronization time information with an OTP module 112 in the time synchronization system.

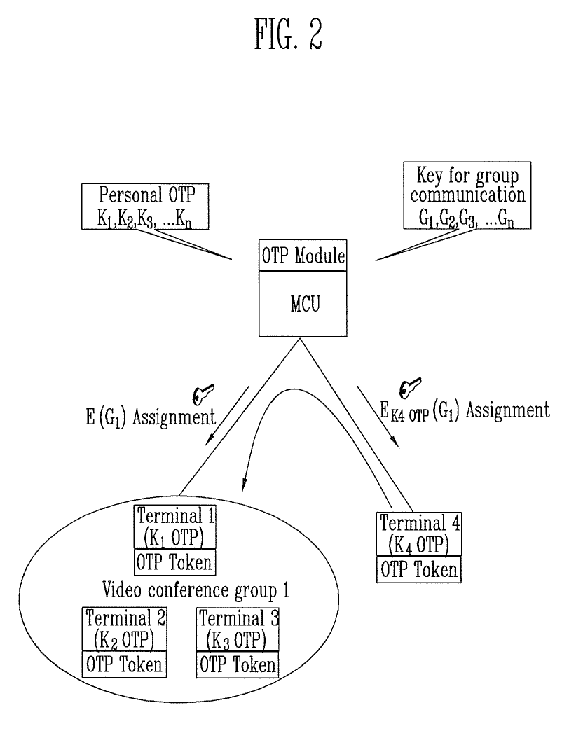

FIG. 2 schematically shows a process in which a video terminal participates in a video conference in a video conference system according to the present invention.

Referring to FIG. 2, terminals 1, 2, and 3 belonging to video conference group 1 perform a video conference using a group key G₁ under support by the MCU. The terminal 4 must be assigned a group key G₁ corresponding to a video conference group 1 to participate in video conference group 1.

The terminal 4 performs a process by which the terminal 4 is assigned the group key G₁ from the MCU in a group key distributing scheme according to the present invention. For assignment of the group key G₁, a one-time password must be first acquired in the challenge/response system or time synchronization system. The one-time password is used to encrypt the group key G₁. The process by which the terminal 4 is assigned the group key will be described below in greater detail in an exemplary embodiment of the present invention.

Meanwhile, upon acquisition of the group key G₁ corresponding to the video conference group 1 in which the terminal 4 desires to participate, the terminal 4 may use the acquired group key G₁ to participate in the video conference group 1.

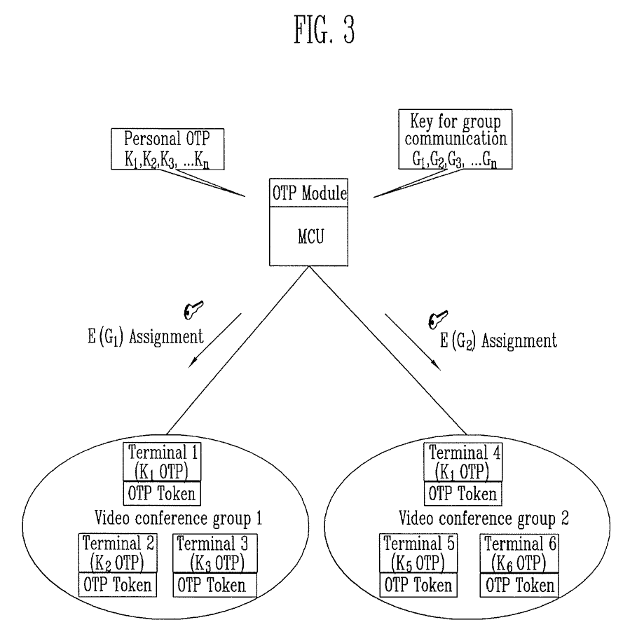

FIG. 3 schematically shows a process of distributing a group key when there are a plurality of video conference groups.

Referring to FIG. 3, a group key G₁ is distributed to the video conference group 1, and a group key G₂ is distributed to the video conference group 2. That is, the group key G₁ is distributed to the terminals 1, 2, and 3 participating in the video conference group 1, and the group key G₂ is distributed to terminals 4, 5, and 6 participating in the video conference group 2.

The group key distributed to the respective terminals is encrypted with a one-time password, uniquely assigned to each terminal, by the MCU and then delivered. The one-time password for determining the group key distributing scheme may be set by either the challenge/response system or the time synchronization system. Further, use of the one-time password in the challenge/response system or the time synchronization system requires the video terminal and the MCU to include an OTP module or an OTP token module included in and cooperating with it.

### A. First Embodiment

A scheme of distributing a group key for a video conference according to a first embodiment of the present invention will be described with reference to relevant figures in greater detail.

The scheme of distributing a group key for a video conference according to the first embodiment of the present invention includes distributing the group key for the video conference in the challenge/response system of the OTP scheme. That is, the first embodiment of the present invention proposes a scheme of acquiring a response value using a challenge value generated as a one-time password, and distributing the group key using the acquired response value. Also, an example in which a request for participation in the video conference is made by the MCU, and an example in which a request for participation in the video conference is made by a video terminal will now be described.

A-1. Example in Which Request for Participation in Video Conference is made by MCU

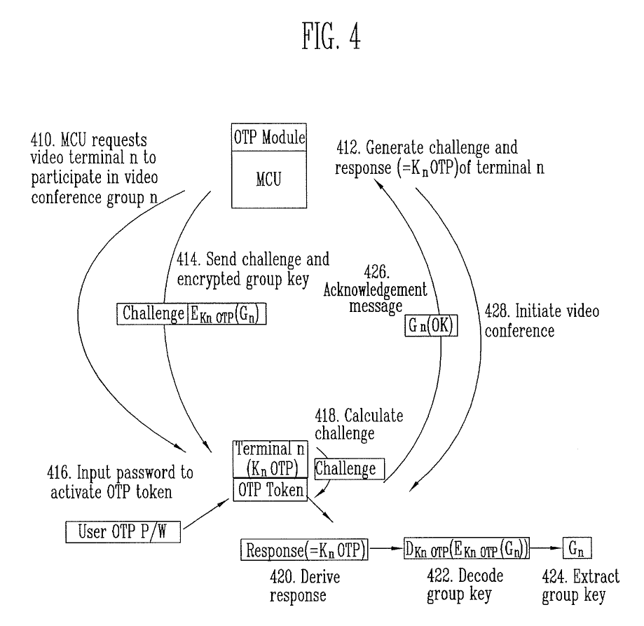

FIG. 4 shows a signal processing flow in a video conference system of distributing a group key according to the first embodiment of the present invention. That is, FIG. 4 shows a general process of causing any video terminal to participate in a video conference in response to a request for the MCU in a video conference system using a challenge/response system.

Referring to FIG. 4, the MCU sends a video conference participation request message to a video terminal n in step 410. The OTP module of the MCU generates a challenge value and a response value corresponding to the video terminal n in step 412. The response value corresponds to OTP (Kₙ OTP, where Kₙ denotes an index for identifying a video terminal) corresponding to the video terminal n.

The MCU selects a group key Gₙ corresponding to the video conference in which the MCU causes the video terminal n to participate, and encrypts a control message including the selected group key Gₙ with the response value. The MCU generates the challenge value generated by the OTP module and the encrypted group key E_{Kn OTP}(Gn), and sends the control message to the video terminal in step 414.

Upon receipt of the video conference participation request message in step 410, the video terminal n performs a process of activating an OTP token module in step 416. The activation of the OTP token module serves to block, through user authentication, an unauthorized user from participating in the video conference. The OTP token module is activated according to whether the input user OTP passes the user authentication.

Upon receipt of the control message from the MCU in step 414, the video terminal n extracts a challenge value from the received control message in step 418. The video terminal n provides the extracted challenge value and the encrypted group key in the control message to the OTP token module.

The OTP token module calculates a response value from the challenge value in step 420. The response value calculated by the OTP token module corresponds to an OTP corresponding to the video terminal n. The OTP token module decodes the encrypted group key E_{Kn OTP}(Gn) in the control message with the response value Kₙ OTP in step 422 to acquire a desired group key Gn in step 424. Decoding of the encrypted group key may be generalized as shown in Expression 1:

D_{Kn OTP}(E_{Kn OTP}(Gn)) Expression 1

After acquiring the group key, the video terminal n generates an acknowledgement message Gn OK using the group key, and sends the generated acknowledgement message Gn OK to the MCU in step 426. The video terminal then initiates the video conference by participating in the video conference in step 428.

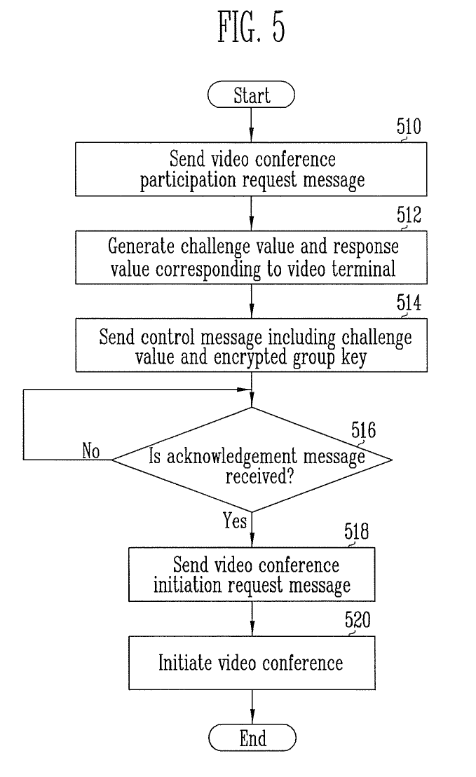

FIG. 5 shows a control flow in an MCU for initiating a video conference through group key distribution according to the first embodiment of the present invention. That is, FIG. 5 shows a control flow in the MCU in which the MCU requests a video terminal to participate in a video conference, which is initiated by the group key distributed by the MCU.

Referring to FIG. 5, the MCU sends a video conference participation request message to any video terminal in step 510. The video terminal is a terminal desiring to participate in the video conference. The video conference participation request message may be sent when a video conference is newly initiated, as well as when a new video terminal is required to participate in an ongoing video conference. The MCU may provide information for identifying a video conference to be participated in by the video terminal (e.g., video conference group index) on the video conference participation request message. In addition, the video conference participation request message may be broadcast to a plurality of video terminals. Preferably, the video conference participation request message may include information for identifying a plurality of video terminals requesting video conference participation.

The OTP module of the MCU generates a challenge value and a response value corresponding to the video terminal in step 512. The video terminal is a video terminal requested for participation in the video conference and registered in the MCU. The response value corresponds to OTP (Kₙ OTP, where Kₙ denotes an index for identifying a video terminal) corresponding to the video terminal. The OTP module may be included in the MCU or a separate device. Even when the OTP module is separate from the MCU, it must be able to be controlled by the MCU.

The MCU then generates a control message including the challenge value generated by the OTP module and the encrypted group key E_{Kn OTP}(Gn) in step 514, and sends the control message to the video terminal. For this, the MCU selects a group key Gₙ corresponding to the video conference in which it desires to cause the video terminal to participate, and encrypts the selected group key Gₙ. The selected group key G₁, is encrypted with the generated response value Kₙ OTP.

The MCU monitors whether an acknowledgement message corresponding to the control message is received from the video terminal in step 516. The acknowledgement message is sent by the group key from the video terminal.

Upon receipt of the acknowledgement message, the MCU causes the video terminal to participate in the video conference by sending a video conference initiation request message to the video terminal to indicate video conference initiation in step 518. The MCU initiates the video conference in step 520.

Meanwhile, although the MCU uses the video conference initiation request message to cause the video terminal to participate in the video conference, it may cause the video terminal to participate in the video conference using the received acknowledgement message without transmitting a separate message.

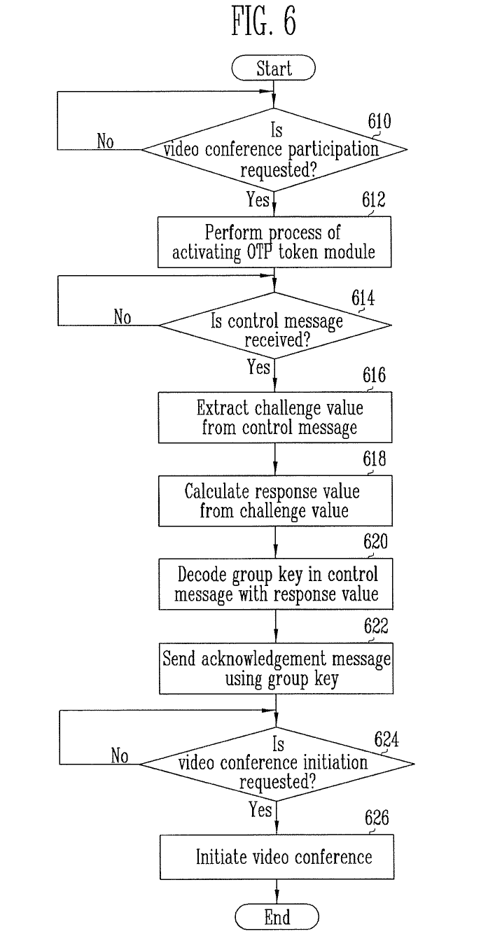

FIG. 6 shows a control flow in a video terminal for initiating a video conference through group key distribution according to the first embodiment of the present invention. That is, FIG. 6 shows a control flow in the video terminal in which the MCU requests the video terminal to participate in the video conference, which is initiated by the group key distributed by the MCU.

Referring to FIG. 6, the video terminal determines in step 610 whether a request for participation in the video conference is received from the MCU. The determination may be made based on whether a video conference participation request message is received. The video conference requested for participation from the MCU may include a video conference to be newly initiated, as well as an ongoing video conference. The video conference participation request message may include information for identifying a video conference to be participated by the video terminal (e.g., video conference group index). In addition, the video conference participation request message may be broadcast to a plurality of video terminals. Preferably, the video conference participation request message includes information for identifying each of a plurality of video terminals requesting video conference participation. The video terminal may determine whether the request for participation in the video conference is directed to the video terminal based on the information for identifying the video terminal in the video conference participation request message.

The video terminal performs a process of activating the OTP token module in step 612. Activating the OTP token module serves to block, through user authentication, an unauthorized user from participating in the video conference.

Specifically, in response to the request for participation in the video conference from the MCU, the user picks up the video terminal and inputs the assigned OTP. In this case, the user must have been notified, by the video terminal, of the video conference participation request being received from the MCU. The request for participation in video conference is provided to the user by a display device such as display or a lightning or an audible device such as a call sound.

The video terminal verifies a user-input OTP to confirm whether the user is authenticated. If the user is authenticated, the video terminal activates the OTP token module. The OTP token module may be included in the video terminal or as a separate device. Even when the OTP module is separate from the video terminal, the OTP module must be able to be controlled by the video terminal. Meanwhile, the activation of the OTP token module means that a function for sharing the MCU and the OTP is activated by the response/challenge system.

The video terminal monitors whether a control message is received from the MCU in step 614. Here, the control message includes the challenge value generated by the OTP module of the MCU and the encrypted group key E_{Kn OTP}(Gn). Upon receipt of the control message, the video terminal provides the received control message to the OTP token module. The OTP token module extracts the challenge value from the control message in step 616. The OTP token module calculates a response value from the challenge value in step 618. The response value calculated by the OTP token module corresponds to an OTP corresponding to the video terminal.

The video terminal then decodes the encrypted group key in the control message with the response value to obtain a desired group key in step 620. The group key may be decoded by the OTP token module rather than the video terminal, and the OTP token module may send it to the video terminal.

After obtaining the group key, the video terminal generates an acknowledgement message using the group key, and sends the generated acknowledgement message to the MCU in step 622. The video terminal then determines whether a video conference initiation request message is received from the MCU in step 624. The video conference initiation request message is sent to cause the video terminal to participate in the video conference. Upon receipt of the video conference initiation request message, the video terminal participates in the video conference to initiate the video conference in step 626. However, where the video conference initiation request message is not used for simplification of the process, the receipt of the acknowledgement message may cause the video terminal to participate in the video conference irrespective of receipt of the video conference initiation request message.

As described above, according to the first embodiment of the present invention, for the video conference to be carried out by the request for participation in a video conference from the MCU, the OTP module of the MCU generates the challenge value and the response value corresponding to the OTP, and provides the generated challenge value and the group key encrypted with the response value to the video terminal. The video terminal calculates the response value from the challenge value, and decodes the encrypted group key with the response value to acquire a desired group key. The MCU and the video terminal share the group key, so that the video terminal can participate in the video conference.

A-2. Example in Which Request for Participation in Video Conference is made by Video Terminal

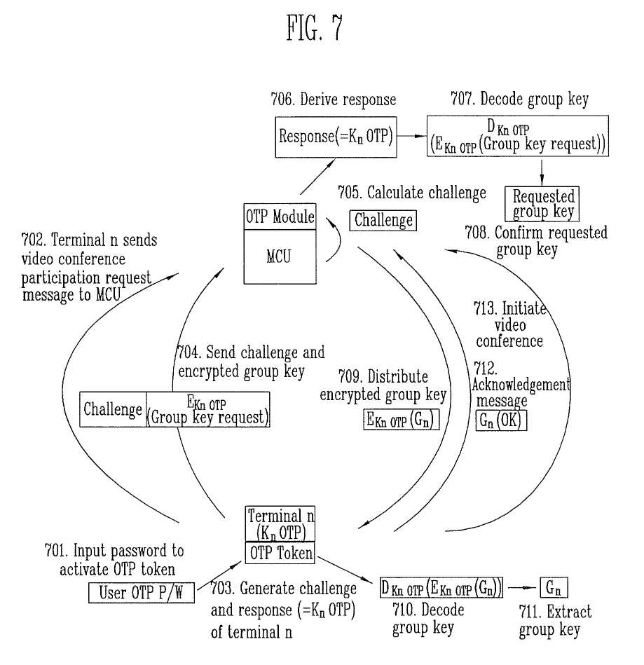

FIG. 7 shows a signal processing flow in a video conference system of distributing a group key according to the first embodiment of the present invention. That is, FIG. 7 shows a general process of participating in a video conference in response to a request from a video terminal in a video conference system using a challenge/response system.

Referring to FIG. 7, a video terminal n performs a process of activating an OTP token module in step 701. The activation of the OTP token module serves to block, through user authentication, an unauthorized user from participating in the video conference. The OTP token module is activated according to whether the user picks up the video terminal and inputs the user OTP and the input user OTP passes user authentication.

The video terminal n sends a video conference participation request message to the MCU in step 702. The OTP token module of the video terminal n generates a challenge value and a response value in step 703. The response value corresponds to the OTP (Kₙ OTP, where Kₙ denotes an index for identifying a video terminal) of the video terminal n.

The video terminal encrypts the group key request message with the response value Kₙ OTP, and sends the challenge value and the encrypted group key request message E_{Kn OTP} (group key request) to the MCU in step 704.

Upon receipt of the control message from the video terminal n in step 704, the MCU extracts the challenge value from the received control message in step 705. The MCU then provides the extracted challenge value and the encrypted group key request message E_{Kn OTP} (group key request) in the control message to the OTP module.

The OTP module derives the response value using the challenge value in step 706. The derived response value corresponds to a one-time password, Kₙ OTP, corresponding to the video terminal n. The OTP module decodes the encrypted group key request message E_{Kn OTP} (group key request) in the control message with the response value Kₙ OTP in step 707. In step 708, the OTP module confirms, from the decoded message, a group key desired by the video terminal n. Decoding of the encrypted group key request message may be generalized as shown in Expression 2.

D_{Kn OTP}(E_{Kn OTP}(group key request)) Expression 2

The MCU selects the confirmed group key Gn, and encrypts the selected group key Gn with the response value Kn OTP. The MCU transmits the encrypted group key E_{Kn OTP}(Gn) to the video terminal n in step 709.

The OTP token module decodes the encrypted group key E_{Kn OTP}(Gn) in the control message with the response value Kn OTP in step 710 to acquire a desired group key Gn in step 711. The encrypted group key may be expressed as shown in Expression 1.

After acquiring the group key, video terminal n generates an acknowledgement message Gn OK using the group key, and sends the generated acknowledgement message Gn OK to the MCU in step 712. The video terminal then initiates the video conference through participation in the video conference in step 713.

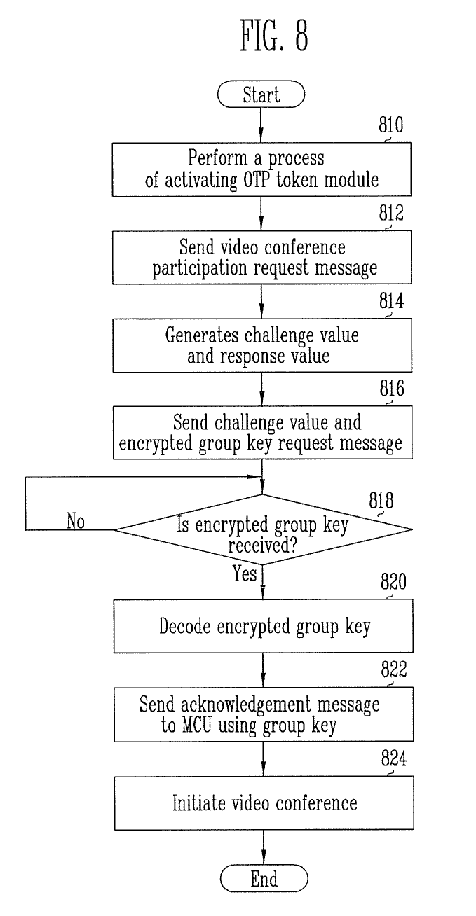

FIG. 8 shows a control flow in a video terminal for initiating a video conference through group key distribution according to the first embodiment of the present invention. That is, FIG. 8 shows a control flow in a video terminal in which a video terminal makes a request for participation in the video conference, which is initiated with a group key distributed by the MCU.

Referring to FIG. 8, the video terminal performs a process of activating an OTP token module in response to a request from a user in step 810. The activation of the OTP token module serves to block, through user authentication, an unauthorized user from participating in the video conference.

Specifically, when attempting to participate in a specific video conference, the user picks up the video terminal and inputs his or her assigned OTP. The video terminal verifies the user-input OTP to determine whether the user is authenticated. When the user is authenticated, the video terminal activates the OTP token module. The OTP token module may be included in the video terminal or as a separate device. Even when the OTP module is separate from the video terminal, the OTP module must be able to be controlled by the video terminal. Meanwhile, the activation of the OTP token module means that a function for sharing the MCU and the OTP has been activated by the response challenge system.

When the OTP token module is activated, the video terminal sends a video conference participation request message to the MCU in step 812. The video conference participation request message may be sent to request to participate in an ongoing video conference, as well as a video conference to be newly initiated. The video conference participation request message may include information identifying a video conference to be participated in by the user (e.g., video conference group index), and information identifying the video terminal.

The OTP token module of the video terminal generates a challenge value and a response value in step 814. The response value is the same as OTP (Kₙ OTP, where Kₙ denotes an index for identifying a video terminal) corresponding to the video terminal.

The video terminal then encrypts the group key request message with the generated response value. The group key request message is a message requesting a group key corresponding to the video conference in which the video terminal participates. The video terminal sends the challenge value generated by the OTP token module and the encrypted group key request message to the MCU in step 816.

The video terminal monitors whether the control message is received from the MCU in step 818. Here, control message includes group key E_{Kn OTP}(Gn) encrypted by the MCU. Upon receipt of the control message, the video terminal decodes the encrypted group key included in the control message with the previously generated response value to acquire a desired group key in step 820. The group key is decoded by the OTP token module rather than the video terminal and then the OTP token module may send the same to the video terminal.

After acquiring the group key, the video terminal generates an acknowledgement message using the group key, and sends the generated acknowledgement message to the MCU in step 822. The video terminal then attempts to participate in the video conference to participate in the desired video conference through the attempt in step 824.

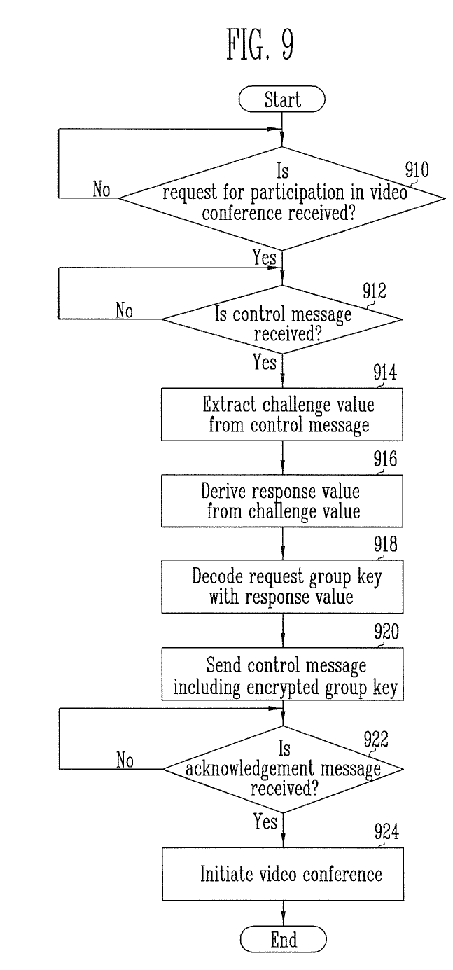

FIG. 9 shows a control flow in an MCU of initiating video conference through group key distribution according to the first embodiment of the present invention. That is, FIG. 9 shows a control flow in the MCU in which the video terminal makes a request for participation in the video conference, which is initiated by the group key distributed by the MCU.

Referring to FIG. 9, the MCU determines in step 910 whether a request for participation in the video conference is received from the video terminal. This determination may be made based on whether a video conference participation request message is received. The video conference requested for participation from the video terminal may include video conference to be newly initiated, as well as ongoing video conference. Also, the video conference participation request message may include information identifying video conference to be participated by the user (e.g., video conference group index), and information identifying the video terminal. In this case, the MCU video may identify conference to be participated by the user and a video terminal desiring to participate in the video conference by receiving the video conference participation request message.

The MCU monitors whether a control message is received from the video terminal in step 912. Here, the control message includes the challenge value generated by the OTP token module of the video terminal and the encrypted group key request message. Upon receipt of the control message, the MCU provides the received control message to the OTP module. The OTP module extracts the challenge value from the control message in step 914. The OTP module calculates a response value from the challenge value in step 916. The response value calculated by the OTP module corresponds to an OTP corresponding to the video terminal.

The MCU then decodes the encrypted group key in the control message request message with the response value to confirm a group key corresponding to the video conference in which the video terminal participates in step 918. The group key request message may be decoded by the OTP module rather than the MCU and then the OTP module may send the same to the MCU.

The MCU encrypts the previously confirmed group key with the response value, and generates a control message including the encrypted group key. The MCU sends the generated control message to the video terminal in step 920. The MCU then monitors whether an acknowledgement message corresponding to the control message is received from the video terminal in step 922. The acknowledgement message is sent by the group key from the video terminal.

Upon receipt of the acknowledgement message, the MCU initiates the video conference with the video terminal in step 924.

As described above, according to the first embodiment of the present invention, for the video conference to be carried out by the request for participation in video conference from the video terminal, the OTP token module of the video terminal generates the challenge value and the response value corresponding to the OTP, and provides the generated challenge value and the group key request message encrypted with the response value to the MCU. The MCU calculates the response value from the challenge value, and acquires the group key desired by the video terminal from the group key request message encrypted by the response value. Also, the MCU encrypts the acquired group key with the response value and sends the same to the video terminal, so that the MCU and the video terminal share the group key.

### B. Second Embodiment

A scheme of distributing a group key for a video conference will now be described in greater detail with reference to relevant figures according to a second embodiment of the present invention.

The scheme of distributing a group key for a video conference according to the second embodiment of the present invention includes distributing the group key for the video conference in the time synchronization system of the OTP scheme. That is, the second embodiment of the present invention proposes a scheme of generating an OTP based on the synchronization time information between the video terminal and the MCU, and distributing the group key using the generated OTP. In the second embodiment of the present invention, an example in which a request for participation in the video conference is made by an MCU, and an example in which a request for participation in the video conference by a video terminal will be described.

B-1. Example in Which Request for Participation in Video Conference is made by MCU

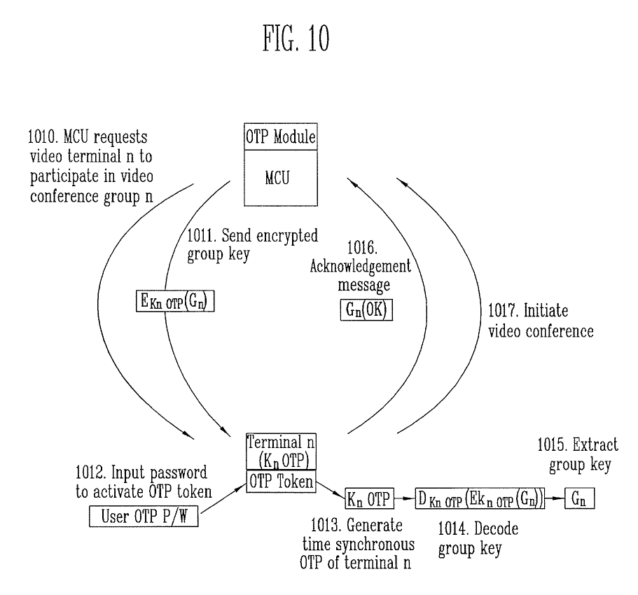

FIG. 10 shows a signal processing flow in a video conference system of distributing a group key according to the second embodiment of the present invention. That is, FIG. 10 shows a general process of causing any video terminal to participate in a video conference in response to a request from the MCU in a video conference system using a time synchronization system.

Referring to FIG. 10, an MCU sends the video conference participation request message to the video terminal n in step 1010. The OTP module of the MCU generates a one-time password Kn OTP corresponding to the video terminal n. The Kₙ OTP is generated using the unique value of the time-synchronous OTP token of the video terminal n registered in the MCU. That is, the one-time password Kₙ OTP is generated at a specific time based on synchronization time information between the video terminal and the MCU according to the time synchronization system. And, the MCU encrypts the group key assigned to the video terminal n with the generated one-time password Kn OTP, and sends the encrypted group key E_{Kn OTP}(Gn) in step 1011.

Upon receipt of the video conference participation request message, the video terminal n performs a process of activating an OTP token module in step 1012. The activation of the OTP token module serves to block, through user authentication, an unauthorized user from participating in the video conference. The OTP token module is activated according to whether the user picks up the video terminal and inputs the user OTP and the input user OTP passes the user.

The OTP token module of the video terminal n generates its own one-time password Kn OTP in step 1013. The Kₙ OTP is generated using the unique value of the time-synchronous OTP token of the video terminal n registered in the MCU. That is, the one-time password Kₙ OTP is generated at a specific time based on synchronization time information between the video terminal and the MCU according to the time synchronization system.

The OTP token module of the video terminal n decodes the encrypted group key E_{Kn OTP}(Gn) in the control message received from the MCU with the generated one-time password Kn OTP in step 1014. The OTP token module of the video terminal n acquires a desired group key Gn by decoding the encrypted group key E_{Kn OTP}(Gn) in step 1015. Decoding of the encrypted group key may be expressed as shown in Expression 1.

After acquiring the group key, the video terminal n generates an acknowledgement message Gn OK using the group key, and sends the generated acknowledgement message Gn OK to the MCU in step 1016. The video terminal then initiates the video conference through participation in the video conference in step 1017.

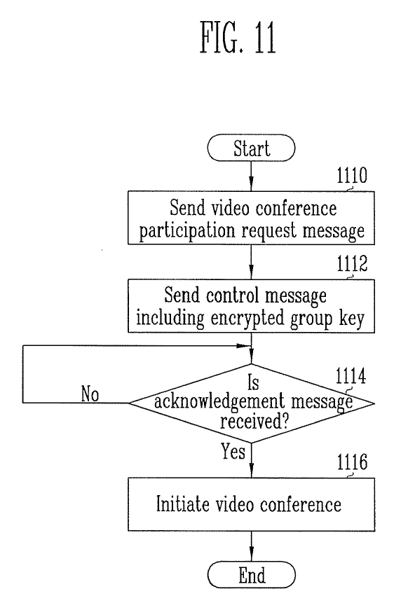

FIG. 11 shows a control flow in the MCU for initiating a video conference through group key distribution according to the second embodiment of the present invention. That is, FIG. 11 shows a control flow in the MCU in which the MCU requests the video terminal to participate in the video conference, which is initiated by the group key distributed by the MCU.

Referring to FIG. 11, the MCU sends a video conference participation request message to any video terminal in step 1110. The video terminal indicates a terminal desiring to participate in the video conference. The video conference participation request message may be sent when the video conference is newly initiated, as well as when a new video terminal is required to participate in an ongoing video conference. The MCU may also provide information for identifying a video conference to be participated in by the video terminal (e.g., video conference group index) on the video conference participation request message. In addition, the video conference participation request message may be broadcast to a plurality of video terminals. Preferably, the video conference participation request message includes information for identifying a plurality of video terminals that requests video conference participation.

The OTP module of the MCU generates a control message including the encrypted group key E_{Kn OTP}(Gn) and sends the control message to the video terminal in step 1112. For this, the MCU selects a group key Gₙ corresponding to the video conference in which it desires to cause the video terminal to participate, and encrypts the selected group key Gₙ. The selected group key Gₙ is encrypted with the one-time password Kn OTP. The one-time password Kₙ OTP is generated at a specific time based on synchronization time information between the video terminal and the MCU according to the time synchronization system. That is, the one-time password Kₙ OTP is generated using a unique value of the time-synchronous OTP token of the video terminal registered in the MCU.

The MCU monitors whether the acknowledgement message corresponding to the control message is received from the video terminal. The acknowledgement message is sent by the group key from the video terminal in step 1114.

Upon receipt of the acknowledgement message, the MCU causes the video terminal to participate in the video conference and then initiates the video conference in which the video terminal participates in step 1116.

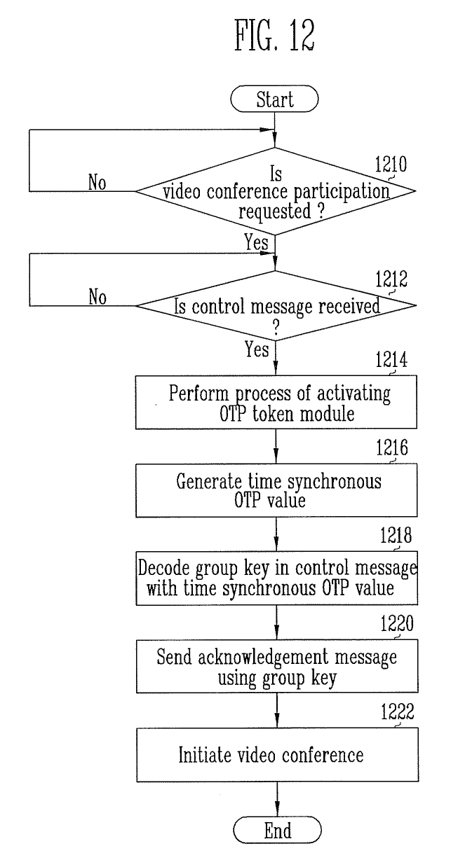

FIG. 12 shows a control flow in a video terminal for initiating a video conference through group key distribution according to the second embodiment of the present invention. FIG. 12 shows a control flow in a video terminal in which an MCU requests the video terminal to participate in the video conference and the video terminal participates in the video conference using the group key distributed by the MCU.

Referring to FIG. 12, the video terminal determines whether a request for participation in the video conference is received from the MCU in step 1210. The determination may be made based on whether a video conference participation request message is received. The video conference requested for participation from the MCU includes a video conference to be newly initiated, as well as an ongoing video conference. Meanwhile, if the video conference participation request message includes information for identifying a video terminal, the video terminal may be implemented for determining whether the video terminal is required to participate in the video conference, based on the identification information included in the video conference participation request message. If the video conference participation request message is broadcast, the video terminal may be implemented for determining whether the video terminal is required to participate in the video conference, based on the identification information included in the video conference participation request message.

The video terminal monitors whether the control message is received from the MCU in step 1212. Here, the control message includes group key E_{Kn OTP}(Gn) encrypted by a one-time password generated by the OTP module of the MCU.

The video terminal performs a process of activating an OTP token module in step 1214. The activation of the OTP token module serves to block, through user authentication, an unauthorized user from participating in the video conference.

Specifically, in response to the request for participation in the video conference from the MCU, the user picks up the video terminal and inputs his or her assigned OTP. In this case, the user must have been notified, by the video terminal, of the video conference participation request being received from the MCU. The request for participation in the video conference is provided to the user by a display device such as display or a lightning or an audible device such as a call sound.

The video terminal verifies the user-input OTP to determine whether the user is authenticated. When the user is authenticated, the video terminal activates the OTP token module. The OTP token module may be included in the video terminal or as a separate device. Even when the OTP module is separate from the video terminal, the OTP module must be able to be controlled by the video terminal. Meanwhile, the activation of the OTP token module means that a function for sharing the MCU and the OTP has been activated by the response challenge system.

Meanwhile, while the OTP token module is shown in FIG. 12 as being activated after the control message is received, the OTP token module may be activated before the control message is received.

When the control message is received and the OTP token module is activated, the video terminal provides the received control message to the OTP token module. The OTP token module generates a one-time password Kn OTP in step 1216. The one-time password Kₙ OTP is generated at a specific time based on synchronization time information between the video terminal and the MCU according to the time synchronization system. That is, the one-time password Kₙ OTP is generated using an unique value of the time-synchronous OTP token of the video terminal.

The video terminal decodes the encrypted group key in the control message with the generated one-time password Kₙ OTP to acquire a desired group key in step 1218. The group key is decoded by the OTP token module rather than the video terminal and then the OTP token module may send the same to the video terminal.

After acquiring the group key, the video terminal generates an acknowledgement message using the group key, and sends the generated acknowledgement message to the MCU in step 1220. The video terminal then participates in the video conference for the video conference with the MCU in step 1222.

As described above, according to the second embodiment of the present invention, for the video conference to be carried out by the request for participation in the video conference from the MCU, the OTP module of the MCU generates the one-time password using time synchronization system, and provides the group key encrypted by the generated one-time password to the video terminal. The video terminal generates the one-time password using the time synchronization system, and decodes the group key encrypted by the generated one-time password to acquire a desired group key. This allows the MCU and the video terminal to share the group key, so that the video terminal participates in the video conference.

B-2. Example in Which Request for Participation in Video Conference is made by Video Terminal

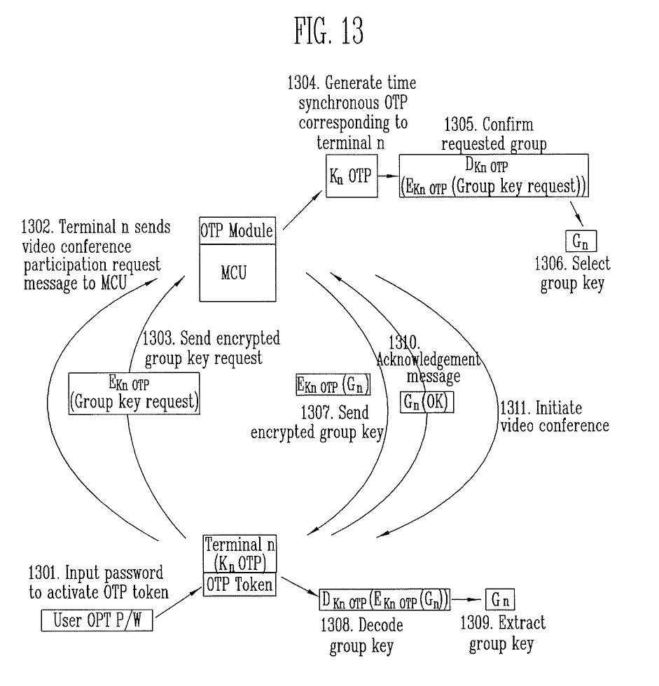

FIG. 13 shows a signal processing flow in a video conference system of distributing a group key according to a second embodiment of the present invention. That is, FIG. 13 shows a general process of causing a video terminal to participate in a video conference in response to a request from the video terminal in a video conference system using a time synchronization system.

Referring to FIG. 13, the video terminal n performs a process of activating an OTP token module in step 1301. The activation of the OTP token module serves to block, through user authentication, an unauthorized user from participating in the video conference. The OTP token module is activated according to whether the user picks up the video terminal and inputs the user OTP and the input user OTP passes the user authentication.

The video terminal n sends a video conference participation request message to the MCU in step 1302. The OTP token module of the video terminal n generates its own one-time password Kₙ OTP. The Kₙ OTP is generated using a unique value of the time-synchronous OTP token of the video terminal n registered in the MCU. That is, the one-time password Kₙ OTP is generated at a specific time based on synchronization time information between the video terminal and the MCU according to time synchronization system.

The video terminal n also encrypts the group key request message with the generated one-time password Kn OTP, and sends the encrypted group key request message E_{Kn OTP}(group key request) in step 1303.

The OTP module of the MCU generates a one-time password Kn OTP corresponding to the video terminal n in step 1304. The Kₙ OTP is generated using a unique value of the time-synchronous OTP token of the video terminal n registered in the MCU. That is, the one-time password Kₙ OTP is generated at a specific time based on synchronization time information between the video terminal and the MCU according to the time synchronization system.

The OTP module of the MCU then decodes the encrypted group key request message E_{Kn OTP}(group key request) in the control message received from the video terminal n with the generated one-time password Kₙ OTP in step 1305. By decoding the encrypted group key request message, the OTP module of the MCU acquires a desired group key Gn in step 1306. Decoding of the encrypted group key request message may be expressed as shown in Expression 2.

The MCU encrypts the group key assigned to the video terminal n with the generated one-time password Kn OTP and sends the encrypted group key E_{Kn OTP}(Gn) in step 1307.

The OTP token module of the video terminal n generates its own one-time password Kn OTP. The Kₙ OTP is generated using a unique value of a time-synchronous OTP token of the OTP token module. That is, the one-time password Kₙ OTP is generated at a specific time based on synchronization time information between the video terminal and the MCU according to the time synchronization system.

The OTP token module of the video terminal n decodes the encrypted group key E_{Kn OTP}(Gn) in the control message received from the MCU with the generated one-time password Kn OTP in step 1308. By decoding the encrypted group key, the OTP token module of the video terminal n acquires a desired group key Gn in step 1309. Decoding of the encrypted group key may be expressed as shown in Expression 1.

After acquiring the group key, the video terminal n generates an acknowledgement message Gn OK using the group key, and sends the generated acknowledgement message Gn OK to the MCU in step 1310. The video terminal n then initiates the video conference through participation in the video conference in step 1311.

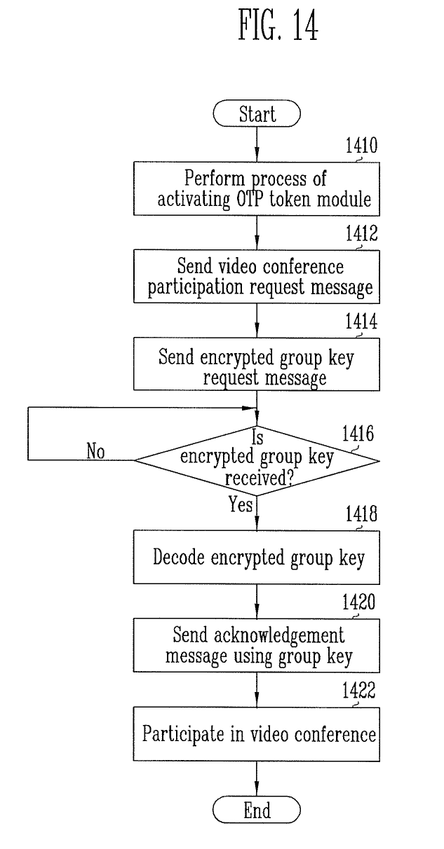

FIG. 14 shows a control flow in a video terminal for initiating a video conference through group key distribution according to a second embodiment of the present invention. That is, FIG. 14 shows a control flow in the video terminal in which the video terminal makes a request for participation in the video conference, which is initiated by the group key distributed by the MCU.

Referring to FIG. 14, the video terminal performs a process of activating an OTP token module in response to a request from a user in step 1410. The activation of the OTP token module serves to block, through user authentication, an unauthorized user from participating in the video conference.

Specifically, when attempting to participate in a specific video conference, a user picks up the video terminal and inputs his or her assigned OTP. The video terminal verifies the user-input OTP to determine whether the user is authenticated. When the user is authenticated, the video terminal activates the OTP token module. The OTP token module may be included in the video terminal or as a separate device. Even when the OTP module is separate from the video terminal, the OTP module must be able to be controlled by the video terminal. Meanwhile, the activation of the OTP token module means that a function for sharing the MCU and the OTP has been activated by the response challenge system.

When the OTP token module is activated, the video terminal sends a video conference participation request message to the MCU in step 1412. The video conference participation request message may be set to request to participate in an ongoing video conference, as well as a video conference to be newly initiated. The video conference participation request message may include information identifying a video conference to be participated by the user (e.g., video conference group index), and information identifying the video terminal.

The OTP token module of the video terminal encrypts the group key request message with one-time password Kn OTP, and sends the encrypted group key request message to the MCU in step 1414. The one-time password Kₙ OTP is generated at a specific time based on synchronization time information between the video terminal and the MCU according to the time synchronization system. That is, the one-time password Kₙ OTP is generated using a unique value of the time-synchronous OTP token of the video terminal.

The video terminal monitors whether the control message is received from the MCU in step 1416. Here, the control message includes the group key E_{Kn OTP}(Gn) encrypted by the MCU. Upon receipt of the control message, the video terminal decodes the encrypted group key included in the control message with the generated one-time password to acquire a desired group key in step 1418. The group key is decoded by the OTP token module rather than the video terminal and then the OTP token module may send the same to the video terminal.

After acquiring the group key, the video terminal generates an acknowledgement message using the group key, and sends the generated acknowledgement message to the MCU in step 1420. The video terminal then attempts to participate in the video conference, and participates in the desired video conference through the attempt in step 1422.

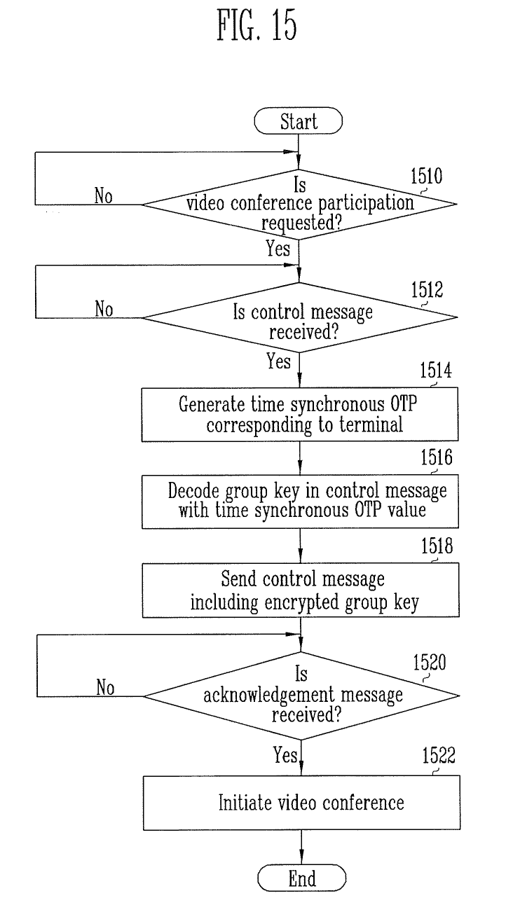

FIG. 15 shows a control flow in an MCU for initiating a video conference through group key distribution according to a second embodiment of the present invention. That is, FIG. 15 shows a control flow in the MCU in which a video terminal makes a request for participation in the video conference, which is initiated by the group key distributed by the MCU.

Referring to FIG. 15, the MCU determines whether a request for participation in the video conference is received from the video terminal in step 1510. The determination may be made based on whether a video conference participation request message is received. The video conference requested for participation from the MCU may include a video conference to be newly initiated, as well as an ongoing video conference. The video conference participation request message may include information identifying a video conference to be participated in by the user (e.g., a video conference group index), and information identifying the video terminal. In this case, the MCU receives the video conference participation request message to identify the video conference to be participated in by the user and a video terminal desiring to participate in the video conference.

The MCU monitors whether a control message is received from the video terminal in step 1512. Here, the control message is a group key request message encrypted with the one-time password generated by the OTP token module of the video terminal.

The OTP module of the MCU generates a one-time password Kn OTP in step 1514. The one-time password Kₙ OTP is generated at a specific time based on synchronization time information between the video terminal and the MCU according to the time synchronization system. That is, the one-time password Kₙ OTP is generated using a unique value of the time-synchronous OTP token of the video terminal registered in the MCU.

The MCU decodes the encrypted group key in the control message request message with a one-time password, to confirm a group key corresponding to the video conference in which the video terminal participates in step 1516. The group key request message may be decoded by the OTP module rather than the MCU and then the OTP module may send the same to the MCU.

The MCU encrypts the group key with the one-time password, and generates a control message including the encrypted group key E_{Kn OTP}(Gn). The MCU sends the control message to the video terminal in step 1518.

The MCU then monitors whether the acknowledgement message corresponding to the control message is received from the video terminal. The acknowledgement message is sent by the group key from the video terminal in step 1520. Upon receipt of the acknowledgement message, the MCU causes the video terminal to participate in the video conference in step 1522.

As described above, according to the second embodiment of the present invention, for the video conference to be carried out by the request for participation in the video conference from the video terminal, the OTP token module of the video terminal generates a one-time password using the time synchronization system, and provides the group key request message encrypted with the generated password to the MCU. The MCU generates a one-time password using the time synchronization system and decodes the group key request message encrypted by the generated one-time password. In response to the decoded group key request message, the MCU encrypts an acquired group key with the one-time password and then sends the same to the video terminal. Thus, the MCU and the video terminal share the group key required for participating in the video conference.

As described above, according to the present invention, a one-time password is used to distribute a group key for a video conference, thereby achieving high-level security against external attack.

According to the present invention, an OTP module of an MCU and an OTP token module of a video terminal distribute a group key, such that an authentication process for a video conference is performed only with simple user authentication, thus achieving user friendliness.

According to the present invention, the use of the one-time password eliminates a need for storage of a password key in a video terminal, which fundamentally prevents an unauthorized user from reusing the key, and protects information in video conference group communication.

While the present invention has been shown and described in connection with exemplary embodiments thereof, it will be apparent to those skilled in the art that modifications and variations can be made without departing from the spirit and scope of the invention as defined by the appended claims.

What is claimed is:

1. A method for distributing a group key in a video conference system, comprising:
when a video terminal is required to participate in a video conference, generating a challenge value and a response value corresponding to the video terminal;
encrypting a group key corresponding to the video conference with the response value, and transmitting the encrypted group key and the challenge value to the video terminal; and
causing the video terminal to participate in the video conference in response to an acknowledgement message from the video terminal.

2. The method of claim 1, further comprising:
receiving, by the video terminal, the challenge value and the group key encrypted with the response value;
decoding the encrypted group key with a response value calculated from the challenge value; and
generating the acknowledgement message using the decoded group key, and transmitting the acknowledgement message to participate in the video conference.

3. A system for distributing a group key in a video conference system, comprising:
a one-time password module for generating a challenge value and a response value corresponding to a video terminal; and
a multipointing control unit for, when the video terminal is required to participate in a video conference, encrypting a group key corresponding to the video conference with the response value, transmitting the encrypted group key and the challenge value to the video terminal, and causing the video terminal to participate in the video conference in response to an acknowledgement message from the video terminal.

4. The system of claim 3, wherein the video terminal comprises a one-time password token module activated by a one-time password input from a user, for receiving the challenge value and the group key encrypted with the response value, and decoding the encrypted group key with a response value calculated from the challenge value.

5. The system of claim 3, wherein the multipointing control unit comprises a one-time password module for receiving the challenge value and a group key request message encrypted with the response value from the video terminal, decoding the encrypted group key request message with the response value calculated from the challenge value, and confirming a requested group key from the decoded group key request message.

6. A method for distributing a group key in a video conference system, comprising:
when a video terminal is required to participate in a video conference, generating a one-time password at a specific time based on synchronization time information with the video terminal;
encrypting a group key corresponding to the video conference with the generated one-time password and transmitting the encrypted group key to the video terminal; and
causing the video terminal to participate in the video conference in response to an acknowledgement message from the video terminal.

7. The method of claim 6, further comprising:
generating a one-time password at a specific time based on the synchronization time information of the video terminal with a multipointing control unit;
decoding an encrypted group key received from the multipointing control unit with the generated one-time password; and
transmitting an acknowledgement message generated by the decoded group key to participate in the video conference.

8. A system for distributing a group key in a video conference system, comprising:
a one-time password module for generating a one-time password at a specific time based on synchronization time information with a video terminal; and
a multipointing control unit for, when a video terminal is required to participate in a video conference, encrypting a group key corresponding to the video conference with the generated one-time password, transmitting the encrypted group key to the video terminal, and causing the video terminal to participate in the video conference in response to an acknowledgement message from the video terminal.

9. The system of claim 8, wherein the video terminal comprises a one-time password token module for generating a one-time password at a specific time based on synchronization time information with the multipointing control unit, and decoding the encrypted group key with the generated one-time password to acquire a group key.

10. The system of claim 8, wherein the multipointing control unit comprises a one-time password module for receiving the encrypted group key request message, decoding the encrypted group key request message with the one-time password, and acquiring a group key corresponding to the video conference using the decoded group key request message.
